(19) United States
(12) Patent Application Publication
(10) Pub. No.: US 2017/0001217 A1
(43) Pub. Date: Jan. 5, 2017

(54) METHOD FOR FORMING MULTILAYER COATING FILM

(71) Applicant: NIPPON PAINT AUTOMOTIVE COATINGS CO., LTD., Osaka (JP)

(72) Inventor: Shinichi FUJIWARA, Osaka (JP)

(21) Appl. No.: 15/107,418

(22) PCT Filed: Dec. 26, 2014
(86) PCT No.: PCT/JP2014/084611

§ 371 Date: Jun. 22, 2016

(30) Foreign Application Priority Data
Dec. 27, 2013 (JP) 2013-273599

(51) Int. Cl. B05D 7/00; B05D 3/02; B05D 1/00; B05D 1/02; C08K 3/34; C09D 5/22; C09D 5/44; C09D 5/02; C09D 133/08; C08K 3/08; B05D 5/06; C25D 13/02

(52) U.S. Cl. CPC B05D 7/572; B05D 5/063; B05D 3/0254; B05D 1/007; B05D 1/02; C25D 13/02; C09D 5/22; C09D 5/4411; C09D 5/022; C09D 5/028; C09D 133/08; C08K 3/08; C08K 3/34; B05D 2202/10; C08K 2003/0812

(57) ABSTRACT

A method for forming a multilayer coating film, including a first base coating composition application step for applying a first basecoat containing a colored pigment and a photoluminescent pigment, a second base coating composition application step for applying a second base coating composition containing a colored pigment and a photoluminescent pigment to the object having undergone the first base coating composition application, a top clear coat application step for applying a top clear coating composition to the object having undergone the second base coating composition application step, and a step for heating and curing the uncured coating films, the pigment weight concentration of photoluminescent pigment in the second basecoat is 0.01-1.1 mass %, the first base coating film has a light reflectance of 10-30% in a certain wavelength region, and the second base coating film has a light transmittance of 60-90% in the wavelength region.

### TECHNICAL FIELD

The present invention relates to a method for forming a multilayer coating film. The present invention relates to, in more detail, a method for forming a multilayer coating film having a better feeling of depth.

### BACKGROUND ART

It has been known that a plurality of coating films having various functions are formed on a surface of a base material such as a vehicle outer panel. These plurality of coating films simultaneously protect the base material and provide a high design property, thus, largely contribute to improve an appearance of an automobile, and resultantly to evoke buyer's willingness to buy the automobile.

Further, in recent years, as applications of the vehicle outer panel or the like, a multilayer coating film having a better feeling of depth is being developed. A multilayer coating film having a feeling of depth is usually designed by dividing functions among separate coating films in such a manner that a photoluminescent pigment is contained in a first base coating film of a lower layer, and only a colored pigment is contained in a second coating film of an upper layer.

There is proposed a technology in which, for example, a metallic coating composition (A), a colored coating composition (B) and a clear coating composition (C) are sequentially coated, and a color difference ΔE between a multilayer coating film made of the metallic coating composition (A) and the clear coating composition (C) and a multilayer coating film made of the metallic coating composition (A), the colored coating composition (B) and the clear coat (C) is set within a predetermined range (see Patent Document 1). It is said that according to this technology, the better feeling of depth can be obtained since a metallic coating film of a lower layer can be visually seen through a colored coating film of an upper layer, and a color unevenness of the multilayer coating film can be prevented from occurring even when a film thickness of the colored coating film fluctuates slightly.

Further, there is proposed a technology in which a first coating composition containing a colored component and a photoluminescent material, a second coating composition containing a colored component and a clear coating composition are sequentially coated, and a content of the colored component in the second coating composition is set within an extremely small predetermined range relative to a resin solid content (see Patent Document 2). It is said that, according to this technology, a multilayer coating film having a better feeling of depth and high saturation can be obtained.

Further, there is proposed a technology in which a base coating composition (A) containing a photoluminescent pigment, a clear coating composition (B), a color clear coating composition (C) containing a colored pigment or a dye and a top clear coating composition (D) are sequentially coated, and each of a difference Δh of color phase angle h between a base coating film and a color clear coating film, a difference ΔL of brightness L* between the base coating film and a multilayer coating film and a difference ΔC of saturation C* between base coating film and the multilayer coating film is set within a predetermined range (see Patent Document 3). According to this technology, it is said that a color unevenness of a frame and the like generated in an edge part can be prevented from occurring, and a multilayer coating film having an excellent feeling of depth and high saturation can be obtained (see Patent Document 3).

Still further, there is proposed a technology in which in a method of forming a laminated coating film in which, after forming a first cured coating film by sequentially coating a first aqueous base coating composition containing a photoluminescent pigment and a first clear coating composition followed by baking and curing, a second cured coating film is formed by sequentially coating a second aqueous base coating composition which do not contain the photoluminescent pigment and a top clear coating composition, further followed by baking and curing, each of PWCs of the first aqueous base coating composition and the second aqueous base coating composition is set within a predetermined range, an L* value, a flip-flop value and a C* value of a first cured coating film are defined, and each of a second base coating film thickness, an L* value and a C* value is set within a predetermined range (see Patent Document 4). According to this technology, it is said that a color phase fluctuation due to a film thickness fluctuation can be suppressed, and a high saturation laminated coating film having excellent feeling of depth can be obtained.

Further, there is proposed a technology in which in a method of forming a multilayer coating film by sequentially coating a first aqueous base coating composition containing a photoluminescent pigment, a second aqueous base coating composition containing a colored pigment, and a clear coating composition, coating composition solid concentrations of the first aqueous base coating composition and the second aqueous base coating composition respectively are set within a predetermined range, a film thickness of the first base coating film is set within a predetermined range, and a film thickness ratio of the first base coating film and the second base coating film is set within a predetermined range (see Patent Document 5). It is said that, according to this technology, an orientation property of the photoluminescent pigment can be improved, and a multilayer coating film having a design property with high saturation and a better feeling of depth can be obtained (see Patent Document 5).

Patent Document 1: Japanese Unexamined Patent Application, Publication No. 2000-279877

Patent Document 2: Japanese Patent No. 4455731

Patent Document 3: Japanese Patent No. 4886994

Patent Document 4: Japanese Patent No. 4822991

Patent Document 5: Japanese Unexamined Patent Application, Publication No. 2011-147916

### DISCLOSURE OF THE INVENTION

### Problems to be Solved by the Invention

However, recently, in applications for an automobile outer plate or the like where a higher design property is demanded more than in the prior art, a multilayer coating film having a more excellent feeling of depth is demanded.

Further, in a coating line having a large coating area and a high level of demand for an appearance of a coating film like a coating line of an automobile outer plate or the like, there is a case determined to be a partial defect of the coating film, and a repairing process is performed where after removing only the defect portion by polishing, only this portion is coated again. In a conventional multilayer coating film having a feeling of depth, when a defect in the coating film is repaired, not only the second base coating film of the upper layer but also the first base coating film of the lower layer may be polished. In this case, an orientation of the photoluminescent pigment in the first base coating film is disturbed in the polished portion, thus, even when a coating composition (first base coating composition, second base coating composition) for repair is oversprayed, a granular unpleasant sensation remained in a ring-like shape and there was a difficulty in repairability.

The present invention was achieved in view of the above situation and an object of the invention is to provide a method of forming a multilayer coating film having a feeling of depth better than in the prior art and excellent repairability.

### Means for Solving the Problems

In order to achieve above objects, an aspect of the present invention provides a method of forming a multilayer coating film including: a first base coating composition application step for forming a first base coating film by coating a first base coating composition containing a colored pigment and a photoluminescent pigment on an object to be coated; a second base coating composition application step for forming a second base coating film by coating a second base coating composition containing a colored pigment and a photoluminescent pigment on the object to be coated that has undergone the first base coating composition application step; a top clear coating composition application step for applying a top clear coating composition on the object to be coated that has undergone the second base coating composition application step; and a heating and curing step for heating and curing the uncured coating films on the object to be coated, in which a pigment weight concentration (PWC) of the photoluminescent pigment in the second base coating composition is from 0.01 to 1.1% by mass, the first base coating film formed from the first base coating composition has a light reflectance of from 10 to 30% in a wavelength region corresponding to a paint color of the multilayer coating film in a wavelength of from 400 to 700 nm, and the second base coating film formed from the second base coating composition has a light transmittance of from 60 to 90% in the wavelength region.

A pigment weight concentration (PWC) of the colored pigment in the second base coating composition is preferably from 0.01 to 10% by mass.

The pigment weight concentration (PWC) of the photoluminescent pigment in the first base coating composition is preferably from 10 to 15% by mass.

Any of the photoluminescent pigment in the first base coating composition and the photoluminescent pigment in the second base coating composition is preferably at least one kind of scale-like photoluminescent pigment selected from a group consisting of an aluminum-based photoluminescent pigment and a mica-based photoluminescent pigment.

It is preferable that a first clear coating composition application step for applying a first clear coating composition on the object to be coated that has undergone the first base coating composition application step; and a baking step for baking and curing the uncured coating films on the object to be coated, are included between the first base coating composition application step and the second base coating composition application step.

Another aspect of the present invention provides a multilayer coating film formed by the method of forming the multilayer coating film described above.

### Effects of the Invention

According to the present invention, first, in a first base coating film containing a colored pigment and a photoluminescent pigment, in order to design a first base coating composition such that a light reflectance in a wavelength region corresponding to a paint color of a multilayer coating film is from 10 to 30%, the first base coating film is designed to be a reflective coating film having a high feeling of photoluminescence.

Further, in a second base coating film containing the colored pigment and the photoluminescent pigment, in order to design a second base coating composition such that a light transmittance in a wavelength region corresponding to the paint color of the multilayer coating film is from 60 to 90%, the second base coating film is designed to be a colored transmitting layer coating film having high clarity.

As a result thereof, according to the present invention, a multilayer coating film having a better feeling of depth and a better feeling of cubic photoluminescence than in the prior art can be obtained. Further, the present invention can be preferably applied to a multilayer coating film of the paint color having low brightness and high saturation such as red, blue, and green.

Further, different from conventional ones, the granular unpleasant feeling of a ring-like defect portion of the coating film generated in the past upon repairing can be eliminated since the photoluminescent pigment is contained in the second base coating film.

Therefore, according to the present invention, a multilayer coating film having, in addition to a more excellent feeling of depth and feeling of cubic photoluminescence than in the prior art, excellent repairability can be obtained. Further, according to the present invention, the cost can be reduced because there is no need of separately preparing a repair-dedicated coating composition for the second base coating film and the second base coating composition itself can be used for repairing the second base coating film.

### PREFERRED MODE FOR CARRYING OUT THE INVENTION

Hereinafter, an embodiment of the present invention will be described in detail. An embodiment of the present invention basically includes a first base coating composition application step, a second base coating composition application step, and a heating and curing step of an uncured coating film, but may include steps other than these steps. An embodiment may be, for example, an embodiment that includes the first base coating composition application step, the second base coating composition application step, a top clear coating composition application step and the heating and curing step of an uncured coating film, an embodiment (so-called 4C2B) that includes the first base coating composition application step, a first clear coating composition application step, a first heating and curing step of the uncured coating film (baking step), the second base coating composition application step, the top clear coating composition application step, and a second heating and curing step of the uncured coating film, etc.

A method of forming a multilayer coating film according to a present embodiment that will be described below is a method of forming a multilayer coating film in which 4C2B is applied on an object to be coated, the 4C2B being an embodiment including the first base coat application step, a first clear coating composition application step, a first heating and curing step of an uncured coating film (baking step), the second base coating composition application step, the top clear coating composition application step, and a second heating and curing step of the uncured coating film.

The method of forming the multilayer coating film according to the present embodiment can form a multilayer coating film having, in addition to an excellent feeling of depth and feeling of cubic photoluminescence, excellent repairability.

Here, in the present specification, the “feeling of depth” means a color sensation that is expressed by a color having high saturation while having a low brightness and being a quiet color. This “feeling of depth” is visually evaluated according to a sensory assessment test by an evaluator.

Further, in the present specification, the “feeling of cubic photoluminescence” means a color sensation that solidly feels a sparkling and high feeling of photoluminescence. This “feeling of cubic photoluminescence” is visually evaluated by a sensory assessment test by an evaluator.

### <Object to be Coated>

As an object to be coated, for example, a metal, a plastic, a foam or the like can be used. Among these, the metal to which electrodeposition coating can be applied is preferably used. As for the metal, for example, iron, copper, aluminum, tin, zinc and alloys containing these metals may be used. The method of forming a multilayer coating film according to the present embodiment can be preferably applied to a molded matter formed of these metals, for example, an outer plate of an automobile body or the like.

In case where the above mentioned metal is used as the object to be coated, an electrodeposition coating is preferably applied after applying a chemical conversion treatment in advance with a phosphoric acid or zirconium-based chemical conversion treatment agent. Thus, an excellent anti-rust property is imparted to the object to be coated. Any of the cationic and anionic electrodeposition coating compositions may be used as an electrodeposition coat. However, the cationic electrodeposition coating composition is preferably used from the viewpoint capable of obtaining a more excellent anti-corrosion property.

Examples of plastics include a polypropylene resin, a polycarbonate resin, a urethane resin, a polyester resin, a polystyrene resin, an ABS resin, a vinyl chloride resin, and a polyamide resin. Examples of molded products constituted from these plastics include automobile components such as a spoiler, a bumper, a mirror cover, a grill, and a door knob. When these plastics are used as the object to be coated, it is preferable to cleanse these plastics with pure water or a neutral detergent in advance before coating. Further, in order to make it possible to apply an electrostatic coating, a primer coating may be applied in advance.

The object to be coated used in the present embodiment preferably has an intermediate coating film formed on an electrodeposition coating film in the case of the metal and on a primer coating film in the case of the plastic. This intermediate coating film can be formed by applying an intermediate coating composition followed by baking and curing. Examples of the intermediate coating compositions include aqueous type, solvent type, and powder type intermediate coating compositions.

The intermediate coating composition contains a coating film forming resin made of a colored pigment, an extender, a main agent and a curing agent, and the like. The intermediate coating film made of the intermediate coating composition hides a ground, secures a surface smoothness after top coat coating and improves an appearance, and imparts various physical properties of a coating film such as impact resistance and chipping resistance.

As for the colored pigment used in the intermediate coating composition, various colored pigments can be used irrespective of an organic type and an inorganic type. Known various extenders can be used as the extender. Further, a flat pigment such as aluminum powder and mica powder may be used in combination. For example, other than gray-based intermediate coating composition having carbon black and titanium oxide containing as a primary pigment, a set gray in which the brightness and color phase are equalized with those of the top coat paint color or a so-called color intermediate coating composition in which various kinds of colored pigments are combined may be used.

Examples of main agents constituting the coating film forming resin that is used in the intermediate coating composition include an acrylic resin, a polyester resin, an alkyd resin, an epoxy resin, and a urethane resin. These are used in a combination with the curing agent such as an amino resin and a block isocyanate resin. From the viewpoint of the dispersibility of the pigment and workability, a combination of the alkyd resin or polyester resin with the amino resin can be preferably used.

A cured intermediate coating film is obtained by coating such an intermediate coating composition followed by heating. A heating temperature is generally from 100 to 180° C., and more preferably from 120 to 160° C. A heating time is preferably from 10 minutes to 30 minutes. A film thickness of the intermediate coating film is preferably from 20 to 60 μm, and more preferably from 30 to 40 μm in a dry state.

However, in the present embodiment, the intermediate coating film is not necessarily indispensable. The embodiment may be of an object to be coated without an intermediate coating film, which is so called an intermediate coat-less film. In this case, it is preferable to impart the various physical properties such as an impact resistance property and a chipping resistance property, which the intermediate coating film usually has to a first base coating film described below. Specifically, it is preferable to compound the respective components of the above intermediate coating composition in the first base coating composition.

### <First Base Coating Composition Application Step>

A first base coating composition application step is a step of coating the first base coating composition on the object to be coated. As an application method, an electrostatic coating is preferably used. Specifically, for example, a rotary atomization type electrostatic coating machine is used to coat (the same also in the following electrostatic coating).

An aqueous base coating composition containing the colored pigment, the photoluminescent pigment, and the coating film forming resin can be used as the first base coating composition. The coating film forming resin contains preferably an acrylic emulsion resin, polyether polyol, a urethane emulsion resin and the curing agent.

In the first base coating film (cured) formed from the first base coating composition, a composition of the first base coating composition is adjusted such that the light reflectance in a wavelength region corresponding to the paint color of the multilayer coating film among a wavelength of from 400 to 700 nm is 10 to 30%. Specifically, the light reflectance of the first base coating film (cured) in a wavelength region corresponding to the paint color of the multilayer coating film is adjusted to from 10 to 30% by adjusting compounding types and compounding amounts of the colored pigment and photoluminescent pigment described below. Thus, in the multilayer coating film of each paint color, the first base coating film functions as a reflective layer, and excellent feeling of depth and feeling of cubic photoluminescence can be obtained.

Here, the wavelength region corresponding to the paint color of the multilayer coating film means a wavelength region of 440 to 480 nm when the paint color of the multilayer coating film is blue, for example. Further, when the paint color of the multilayer coating film is, for example, red, the wavelength region means a wavelength region of from 620 to 700 nm, and, when the paint color of the multilayer coating film is, for example, green, the wavelength region means a wavelength region of from 510 to 570 nm.

Here, the paint color of the multilayer coating film is determined to be blue when corresponding to 5B to 10B in a Munsell color system, determined to be red when corresponding to 5R to 10R and determined to be green when corresponding to 5G to 10G.

The light reflectance is measured as shown below.

On a steel plate as the object to be coated, among the multilayer coating film of the present invention, a multilayer coating film (electrodeposition coating film, intermediate coating film, first base coating film) with the first base as a topmost layer is formed, for every 10 nm in a wavelength region corresponding to the paint color, an intensity of light reflected by the multilayer coating film with the first base as the topmost layer is measured by a spectrophotometer (U-3310, manufactured by Hitachi Limited), and the light reflectance is calculated from the measurement.

### [Colored Pigment]

Any of organic-based and inorganic-based colored pigments can be used as the colored pigments compounded in the first base coating composition. Examples of the organic colored pigments include azo chelate-based pigments, insoluble azo-based pigments, condensation azo-based pigments, diketopyrrolopyrrole-based pigments, benzimidazolone-based pigments, phthalocyanine-based pigments, indigo pigments, perinone-based pigments, perylene-based pigments, dioxane-based pigments, quinacridone-based pigments, isoindolinone-based pigments, and metal complex pigments. Further, examples of the inorganic pigments include chrome yellow, yellowish iron oxide, colcothar, carbon black, and titanium oxide. The colored pigment compounded in the first base coating composition is selected such that the second base coating composition and the first base coating composition, which will be described below have the same shade.

A content of the colored pigment in the first base coating composition is preferably from 5 to 20% by mass in the pigment mass concentration (PWC) in the first base coating composition. When the PWC of the colored pigment is less than 5% by mass, the saturation becomes insufficient and the color phase becomes largely different from the second base to generate a color variation. When the PWC exceeds 20% by mass, a color phase difference from the second base becomes smaller and the feeling of depth degrades. More preferably, the PWC is from 7 to 18% by mass. The PWC of the colored pigment is a mass ratio (% by mass) of a total mass of all colored pigments to a total mass of all pigments including pigments other than colored pigments described below and all resin components and is calculated according to the following formula (1).

The PWC of colored pigments=(a total mass of all colored pigments)/(a total mass of all pigments and solid contents of all resin components in first base coating composition)×100(% by mass). formula (1)

### [Photoluminescent Pigment]

Examples of the photoluminescent pigments compounded in the first base coating composition include color free or colored photoluminescent pigments of metals or alloys such as aluminum, copper, zinc, iron, nickel, tin, and aluminum oxide. Further, the photoluminescent pigments such as interference mica, white mica, graphite, and glass flake can be also used.

The photoluminescent pigment has preferably a volume average particle size D₅₀ of from 2 to 50 μm. When the volume average particle size D₅₀ of the photoluminescent pigment is within this range, an excellent photoluminescent feeling can be obtained. A more preferable volume average particle size D₅₀ is from 5 to 35 μm. Further, the photoluminescent pigment uses preferably together a larger one and a smaller one in the volume average particle size within a range of from 2 to 50 μm of the volume average particle size D₅₀. This is because a high feeling of photoluminescence can be obtained from the photoluminescent pigment having a larger volume average particle size, and a high hiding property can be obtained from the photoluminescent pigment having a smaller volume average particle size.

Further, the photoluminescent pigment has preferably a scale-like shape and its thickness is preferably from 0.1 to 5 μm. Thus, a more excellent feeling of photoluminescence can be obtained when the scale-like photoluminescent pigment is oriented such that a surface direction of the pigment is substantially in parallel with the object to be coated.

In the present embodiment, as the photoluminescent pigment compounded in the first base coating composition, at least one kind of the scale-like photoluminescent pigment selected from the group of an aluminum-based photoluminescent pigment and a mica-based photoluminescent pigment is particularly preferably used. Aluminum flake, interference mica or the like can be used as the photoluminescent pigment corresponding to these.

A content of the photoluminescent pigment in the first base coating composition is preferably from 10 to 15% by mass in the pigment mass concentration (PWC) in the first base coating composition. When the PWC of the photoluminescent pigment is within this range, a multilayer coating film having an excellent feeling of depth and feeling of cubic photoluminescence can be obtained. The PWC is more preferably from 10 to 20% by mass. The PWC of the photoluminescent pigment is a mass ratio (% by mass) of a total mass of all photoluminescent pigments to a total mass of all pigments including pigments other than photoluminescent pigments and all resin components and is calculated by the following formula (2).

PWC of photoluminescent pigment=(total mass of all photoluminescent pigments)/(total mass of all pigments and solid contents of all resin components in first base coating composition)×100(% by mass). formula (2)

### [Acrylic Emulsion Resin]

Various types obtained by emulsion polymerizing an alpha, beta-ethylenically unsaturated monomer mixture can be preferably used as the acrylic emulsion resin compounded as the coating film forming resin of the first base coating composition. For example, an acrylic emulsion resin that is obtained by emulsion polymerizing the alpha, beta-ethylenically unsaturated monomer mixture that contains 65% by mass or more of a (meth)acrylic acid ester monomer having one or two carbons in an ester part of a side chain and has an acid value of from 3 to 50 mg KOH/g can be used.

An appearance of the obtained coating film degrades when a content of the (meth)acrylic acid ester monomer having one or two carbons in an ester part of a side chain is less than 65% by mass in the alpha, beta-ethylenically unsaturated monomer mixture. (Meth)acrylic acid methyl and (meth)acrylic acid ethyl can be used as the (meth)acrylic acid ester having one or two carbons in the ester part of the side chain.

The alpha, beta-ethylenically unsaturated monomer mixture has the acid value of preferably from 3 to 50 mg KOH/g and more preferably from 7 to 40 mg KOH/g. The workability may degrade when the acid value is less than 3 mg KOH/g and water resistance of the coating film may degrade when the acid value exceeds 50 mg KOH/g.

Further, the alpha, beta-ethylenically unsaturated monomer mixture has a hydroxyl value of preferably from 10 to 150 mg KOH/g and more preferably from 20 to 100 mg KOH/g. Sufficient curability may not be obtained when the hydroxyl value is less than 10 mg KOH/g, and the water resistance of the coating film may degrade when the hydroxyl value exceeds 150 mg KOH/g.

The alpha, beta-ethylenically unsaturated monomer mixture can be adjusted to the above preferable acid value and hydroxyl value by adjusting the content of the alpha, beta-ethylenically unsaturated monomer having an acid group or a hydroxyl group.

Further, a glass transition temperature of the acrylic emulsion resin obtained by polymerizing the alpha, beta-ethylenically unsaturated monomer mixture is preferably within a range of from −20 to 80° C. from the viewpoint of the physical properties of the coating film.

Examples of acid-containing alpha, beta-ethylenically unsaturated monomers include acrylic acid, methacrylic acid, an acrylic acid dimer, crotonic acid, 2-acryloyloxyethyl phthalic acid, 2-acryloyloxyethyl succinic acid, 2-acryloyloxyethyl acid phosphate, 2-acrylamide-2-methylpropane sulfonic acid, omega-carboxy-polycaprolactone mono(meth)acrylate, isocrotonic acid, alpha-hydro-omega-((1-oxo-2-propenyl)oxy) poly (oxy (1-oxo 1,6-hexanediyl)), maleic acid, fumaric acid, itaconic acid, 3-vinyl salicylic acid, and 3-vinyl acetylsalicylic acid. Among these, acrylic acid, methacrylic acid, and acrylic acid dimer can be particularly preferably used.

Examples of hydroxyl-containing alpha, beta-ethylenically unsaturated monomers include adducts of hydroxyethyl (meth)acrylate, hydroxypropyl (meth)acrylate, hydroxybutyl (meth)acrylate, allyl alcohol, (meth)acryl alcohol, and hydroxyethyl (meth)acrylate with epsilon-caprolactone. Among these, hydroxyethyl (meth)acrylate, hydroxybutyl (meth)acrylate, and an adduct of hydroxyethyl (meth)acrylate and epsilon-caprolactone are particularly preferably used.

The above alpha, beta-ethylenically unsaturated monomer mixture may further contain less than 35% by mass of other alpha, beta-ethylenically unsaturated monomers. Examples of other alpha, beta-ethylenically unsaturated monomers include (meth)acrylic acid esters that have 3 or more carbons in an ester part of a side chain (for example, n-butyl (meth)acrylate, isobutyl (meth)acrylate, t-butyl (meth)acrylate, 2-ethylhexyl (meth)acrylate, lauryl methacrylate, phenyl acrylate, isobornyl (meth)acrylate, cyclohexyl methacrylate, t-butylcyclohexyl (meth)acrylate, dicyclopentadienyl (meth)acrylate and dihydrodicyclopentadienyl (meth)acrylate), polymerizable amide compounds (for example, (meth)acrylamide, N-methylol (meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide 2,4-dihydroxy-4′-vinyl benzophenone, N-(2-hydroxyethyl)acrylamide, and N-(2-hydroxyethyl)methacrylamide), polymerizable aromatic compounds (for example, styrene, alpha-methylstyrene, vinyl ketone, t-butylstyrene, parachlorostyrene, and vinylnaphthalene); polymerizable nitriles (for example, acrylonitrile, and methacrilonitrile); alpha-olefins (for example, ethylene, and propylene); vinyl esters (for example, vinyl acetate, and vinyl propionate; and dienes (for example, butadiene, and isoprene). These are selected depending on an object. However, (meth)acrylamide is preferably used from the viewpoint of providing hydrophilicity.

The alpha, beta-ethylenically unsaturated monomer mixture can be emulsion polymerized according to a known method. Specifically, an emulsion polymerization is performed by dropping the alpha, beta-ethylenically unsaturated monomer mixture and a polymerization initiator while heating and stirring after an emulsifier is dissolved in water or an aqueous medium containing, as needed, an organic solvent such as alcohol. At this time, the alpha, beta-ethylenically unsaturated monomer mixture may be dropped after emulsifying in advance with the emulsifier.

Examples of the polymerization initiators include: azo-based oily compounds (for example, azobisisobutyronitrile, 2,2′-azobis (2-methylbutyronitrile), and 2,2′-azobis (2,4-dimethylvaleronitrile)); azo-based aqueous compounds (for example, anion-based 4,4′-azobis (4-cyanovaleric acid) and cation-based 2,2′-azobis(2-methylpropionamidin)); redox-based oily peroxides (for example, benzoyl peroxide, parachlorobenzoyl peroxide, lauroyl peroxide, and t-butyl par benzoate); and aqueous peroxides (for example, potassium persulfate and ammonium persulfate).

Known emulsifiers are used as the emulsifier. Among these, reactive emulsifiers, for example, Antox MS-60 (manufactured by NIPPON NYUKAZAI CO., LTD.), Eleminol JS-2 (manufactured by Sanyo Chemical Industries, Ltd.), ADEKA REASOAP NE-20 (manufactured by ADEKA, Inc.), Aqualon HS-10 (manufactured by Dai-Ichi Kogyo Seiyaku Co., Ltd.), and the like can be particularly preferably used.

Further, a chain transfer agent such as mercaptan such as lauryl mercaptan and an alpha-methylstyrene dimer may be used, as needed, to adjust a molecular weight of the acrylic emulsion resin.

A reaction temperature is determined by the initiator. For example, it is preferably from 60 to 90° C. for the azo-based initiator, and from 30 to 70° C. for the redox-based initiator. A reaction time is preferably from 1 to 8 hours. An amount used of the initiator to a total amount of the alpha, beta-ethylenically unsaturated monomer mixture is preferably from 0.1 to 5% by mass, and more preferably from 0.2 to 2% by mass.

The above emulsifying polymerization can be performed in two stages. That is, first, a part of the alpha, beta-ethylenically unsaturated monomer mixture (alpha, beta-ethylenically unsaturated monomer mixture 1) is emulsion polymerized, and a remainder of the alpha, beta-ethylenically unsaturated monomer mixture (alpha, beta-ethylenically unsaturated monomer mixture 2) may be further added therein to perform the emulsion polymerization.

In order to form a coating film having an excellent design property, the alpha, beta-ethylenically unsaturated monomer mixture 1 contains preferably an alpha, beta-ethylenically unsaturated monomer having an amide group. Further, at this time, it is preferable that the alpha, beta-ethylenically unsaturated monomer mixture 2 does not contain the alpha, beta-ethylenically unsaturated monomer having an amide group.

A particle size of the acrylic emulsion resin is preferably within a range of from 0.01 to 1.0 μm. When the particle size is less than 0.01 μm, the workability may degrade, and when the particle size exceeds 1.0 μm, the appearance of the obtained coating film may degrade. The particle size of the acrylic emulsion resin can be adjusted by adjusting, for example, a monomer composition or conditions of the emulsifying polymerization. In the present specification, the particle size means a volume average particle size measured by a laser light scattering method.

The acrylic emulsion resin is used preferably within a range of pH of from 5 to 10, as needed, by neutralizing with a base from the viewpoint of stability. The neutralization is performed by adding a tertiary amine like dimethyl ethanolamine or trimethylamine before or after the emulsifying polymerization.

A content of the acrylic emulsion resin in the base coating composition is preferably from 15 to 40%, and more preferably from 20 to 35% as a solid concentration to the solid content of the base coating composition.

### [Polyether Polyol]

A polyether polyol having 0.02 or more of primary hydroxyl groups by average in one molecule and a number average molecular weight of from 300 to 3000 is preferably used as the polyester polyol compounded as the coating film forming resin of the first base coating composition. By containing such polyether polyol, the flip-flop property, water resistance and chipping resistance of the coating film can be improved. In the present specification, the number average molecular weight means a number average molecular weight in terms of polystyrene measured by GPC (gel permeation chromatography).

When the number of the primary hydroxyl groups contained in one molecule of the polyether polyol is less than 0.02 groups on average, the water resistance and the chipping resistance of the coating film degrade. The number of the primary hydroxyl groups contained in one molecule is preferably 0.04 or more and more preferably 1 or more. Other than the primary hydroxyl group, the number of hydroxyl groups including secondary and tertiary hydroxyl groups is preferably 2 or more in one molecule from the viewpoint of the water resistance and chipping resistance of the coating film.

Here, the hydroxyl value of the polyether polyol is preferably from 30 to 700 mg KOH/g. When the hydroxyl value is less than 30 mg KOH/g, the curability may degrade to result in degradation of the water resistance and chipping resistance of the coating film. Further, when the hydroxyl value exceeds 700 mg KOH/g, the stability of the coating composition and the water resistance of the coating film may degrade. A particularly preferable hydroxyl value is from 50 to 500 mg KOH/g.

Further, when the number average molecular weight of polyether polyol is less than 300, the water resistance of the coating film may degrade, and when the number average molecular weight exceeds 3000, the curability and chipping resistance of the coating film may degrade. The particularly preferable number average molecular weight is from 400 to 2000.

A content of the polyether polyol in the first base coating composition is preferably from 1 to 40% by mass and more preferably from 3 to 30% by mass per resin solid content of the first base coating composition. When the content of polyether polyol is less than 1% by mass, the appearance of the coating film may degrade, and, when the content exceeds 40% by mass, the water resistance and chipping resistance of the coating film may degrade.

Examples of the polyether polyols include compounds in which alkylene oxide is added to an active hydrogen-containing compound such as polyalcohol, polyphenol and polycarboxylic acids. Examples of the active hydrogen-containing compounds includes water, polyalcohols (divalent alcohols such as ethylene glycol, diethylene glycol, trimethylene glycol, propylene glycol, 1,4-buthanediol, 1,6-hexanediol, neopentyl glycol, 1,4-dihydroxymethylcyclohexane and cyclohexylene glycol); trivalent alcohols such as glycerin, trioxyisobutane, 1,2,3-butanetriol, 1,2,3-pentanetriol, 2-methyl-1,2,3-propanetriol, 2-methy-2,3,4-butanetriol, 2-ethyl-1,2,3-butanetriol, 2,3,4-pentaneetriol, 2,3,4-hexanetriol, 4-propyl-3,4,5-heptantriol, 2,4-dimethyl-2,3,4-pentantriol, pentamethyl glycerin, pentaglycerin, 1,2,4-butanetriol, 1,2,4-pentantriol, trimethylol ethane and trimethylol propane; tetravalent alcohols such as pentaerythritol, 1,2,3,4-pentanetetrol, 2,3,4,5-hexanetetrol, 1,2,4,5-pentanetetrol, 1,3,4,5-hexanetetrol, diglycerine and sorbitan; pentavalent alcohols such as adonitol, arabitol, xylitol and triglycerine; hexavalent alcohols such as dipentaerythritol, sorbitol, mannitol, iditol, inositol, dulcitol, talose and allose; octavalent alcohols such as sucrose; and polyglycerine); polyphenols [polyphenol (pyrogallol, hydroquinone, and phloroglucin), bisphenols (bisphenol A and bisphenol sulfone)]; polycarboxylic acid [aliphatic polycarbonic acid (succinic acid, adipic acid and the like), aromatic polycarboxylic acid (phthalic acid, terephthalic acid, trimelytic acid and the like)]; and mixtures of two or more kinds thereof.

The polyether polyol can be obtained according to a conventional method by adding alkylene oxide to the active hydrogen-containing compound under the presence of an alkali catalyst under normal pressure or increased pressure and under a temperature condition of from 60 to 160° C. Alkylene oxides such as ethylene oxide, propylene oxide and butylene oxide can be used as the alkylene oxide, and these can be used singularly or in a combination of two or more kinds thereof. An addition form when two or more kinds thereof are used together may be any one of a block polymerization or a random polymerization.

As for the polyether polyol, a commercially available product can be used. For example, Prime Pole PX-1000, Sun Knicks SP-750, PP-400 (all are manufactured by SANYO CHEMICAL INDUSTRIES LTD.), and PTMG-650 (manufactured by MITSUBISHI CHEMICAL CORPORATION) can be used as the polyether polyol.

### [Urethane Emulsion Resin]

As a urethane emulsion resin compounded as the coating film forming resin of the first base coating composition, a urethane emulsion resin obtained, for example, as shown below can be used. First, a urethane prepolymer is generated by making diisocyanate react with glycol having at least 2 active hydrogen or glycol having a carboxylic group at a NCO/OH equivalence ratio of from 0.5 to 2.0. Then, a chain is extended by a chain extender by neutralizing the generated urethane prepolymer with a neutralizing agent. Thereafter, when a cationic, nonionic or anionic surfactant and ion exchange water are added followed by dispersing, the urethane emulsion resin is obtained.

For example, aliphatic, alicyclic or aromatic diisocyanate can be used as the above diisocyanate. Specifically, 2,4-tolylene diisocyanate, 2,6-tolylene diisocyanate, 4,4′-diphenylmethane diisocyanate, m-phenylene diisocyanate, xylylene diisocyanate, tetramethylene di-isocyanate, hexamethylene di-isocyanate, metaxylene diisocyanate, lysine diisocyanate, 1,4-cyclohexylene diisocyanate, 4,4′-dicyclohexylmethane diisocyanate, 3,3′-dimethyl-4,4′-biphenylene di-isocyanate, 3,3′-dimethoxy-4,4′-biphenylene di-isocyanate, 1,5-naphthalene diisocyanate, 1,5-tetrahydronaphthalene diisocyanate, isophorone diisocyanate, and derivatives thereof are used.

Examples of a glycol having the above active hydrogen include low molecular weight glycols such as ethylene glycol, diethylene glycol, triethylene glycol, 1,2-propylene glycol, trimethylene glycol, 1,3-butylene glycol, tetramethylene glycol, hexamethylene glycol, hydrogenated bisphenol A, and ethylene oxide or propylene oxide adducts of bisphenol A; polyoxypropylene glycols; adducts of polyoxypropylene and glycerin, adducts of polyoxypropylene and trimethylolpropane, adducts of polyoxypropylene and 1,2,6-hexanetriol, adducts of polyoxypropylene and pentaerythrit, adducts of polyoxypropylene and sorbitol, methylene-bis-phenyl diisocyanate, polytetrafuranpolyether extended with hydrazine, and derivatives thereof. Further, polyesters and polycaprolactone that are condensates between adipic acid or phthalic acid, and ethylene glycol, propylene glycol, 1,3-butylene glycol, 1,4-butylene glycol, diethylene glycol, hexandiol, 1,2,6-hexanetriol, trimethylolpropane or 1,1,1-trimethylolethane can be also used.

For example, 2,2-dimethylol propionic acid, 2,2-dimethylolbutanoic acid, 2,2-dimethylolvaleric acid and the like can be used as a glycol having the above carboxylic acid group.

As for the above neutralizing agent, for example, amines such as trimethylamine, triethylamine, tri-n-propylamine, tributylamine and triethanolamine, sodium hydroxide, potassium hydrate and ammonia can be used.

Examples of the above-mentioned chain extender include polyols such as ethylene glycol and propylene glycol; aliphatic, alicyclic or aromatic diamines such as ethylenediamine, propylenediamine, hexamethylenediamine, tolylenediamine, xylylene diamine, diphenyldiamine, diaminodiphenylmethane, diaminocyclohexylmethane, piperazine, 2-methylpiperazine, 1,2-bis(2-cyano ethylamino)ethane and isophoronediamine; and water.

As for the above urethane emulsion resin, a commercially available product can be used. Specifically, “VonDick” series and “HYDRAN” series manufactured by DIC Corporation, “IMPRANIL” series manufactured by Bayer Material, and “NeoRez” series such as NeoRez R-940, R-941, R-960, R-962, R-966, R-967, R-962, R-9603, R-9637, R-9618, R-9619 and XR-9624 manufactured by Avecia Resins, “UCOAT”, “UPRENE” and “PERMARIN” series, manufactured by Sanyo Chemical Industries, and “ADEKA BONTIGHTER” series manufactured by ADEKA can be used. These urethane emulsion resins may be used singularly or in a combination of 2 types or more.

A content of the urethane emulsion resin is preferably from 3 to 30 parts by mass per 100 parts by mass of the resin solid content of the first base coating composition. An adhesive property or the like may degrade when the content of the urethane emulsion resin is less than 3 parts by mass, and the storage stability of the coating composition may degrade when the content exceeding 30 parts by mass. Particularly preferably, the content of the resin is from 10 to 25 parts by mass.

### [Curing Agent]

As a curing agent compounded as the coating film forming resin of the first base coating composition, curing agents used in the coating composition in general can be used. Amino resins and block isocyanates are preferably used from the viewpoint of various performances and cost of the obtained coating film.

As for amino resins, other than dimethyl ethanolamine or the like for example, an aqueous melamine resin or a nonaqueous melamine resin can be used. As for these melamine resins, commercially available products can be used. For example, Cymel 204 or the like manufactured by Mitsui Chemical Cytec Ltd. can be used.

As a block isocyanate, a product obtained by adding a blocking agent having active hydrogen to polyisocyanate such as trimethylene diisocyanate, hexamethylene di-isocyanate, xylylene diisocyanate, and isophorone diisocyanate can be used. The block isocyanate, upon heating, dissociates the blocking agent and generates an isocyanate group and this group reacts with a functional group in a resin component to cure the resin.

The content of the curing agent in the first base coating composition is preferably from 15 to 100 parts by mass and more preferably from 15 to 35 parts by mass per 100 parts by mass of the resin solid content in the first base coating composition. The curing property may degrade when the content of the curing agent is less than 15 parts by mass, and the adhesive property and the hot water resistance may degrade when the content exceeds 100 parts by mass.

Further, a total content of the curing agent and the above urethane emulsion resin is preferably from 30 to 60 parts by mass per 100 parts by mass of a coating composition resin solid content. When the total content of the curing agent and urethane emulsion resin is less than 30 parts by mass, the coating workability may degrade, and when the total content exceeds 60 parts by mass, the storage stability of the coating composition may degrade. Particularly preferably, the total content is from 30 to 55 parts by mass.

### [Other Components]

As needed, the first base coating composition may contain other components. For example, the first base coating composition may contain, other than the above acrylic emulsion resin, polyether polyol, urethane emulsion resin and curing agent, other coating film forming resin such as an acrylic resin, a polyester resin, an alkyd resin, and an epoxy resin.

The above other coating film forming resin has the number average molecular weight of preferably from 3000 to 50000 and more preferably from 6000 to 30000. When the number average molecular weight is smaller than 3000, the coating workability and curing property may become insufficient. When the number average molecular weight exceeds 50000, a nonvolatile portion becomes too insufficient during coating and, by contrast, the coating workability may degrade.

The above other coating film forming resin has the acid value of preferably from 10 to 100 mg KOH/g and more preferably from 20 to 80 mg KOH/g. When the acid value exceeds 100 mg KOH/g, the water resistance of the coating film may degrade, and, when the acid value is less than 10 mg KOH/g, the water dispersibility of the resin may degrade.

Further, the above other coating film forming resin has the hydroxyl value of preferably from 20 to 180 mg KOH/g, and more preferably from 30 to 160 mg KOH/g. When the hydroxyl value exceeds 180 mg KOH/g, the water resistance of the coating film may degrade, and when the hydroxyl value is less than 20 mg KOH/g, the curability of the coating film may degrade.

A compounding ratio of the above other coating film forming resin and the above acrylic emulsion resin is preferably from 5 to 95% by mass, more preferably from 10 to 85% by mass, and still more preferably from 20 to 70% by mass of the acrylic emulsion resin to a total amount of the solid contents of both resins. That is, the above other coating film forming resin is preferably from 95 to 5% by mass, more preferably from 90 to 15% by mass, and still more preferably from 80 to 30% by mass, to the total amount of the solid contents of the both resins. When the ratio of the acrylic emulsion resin is less than 5% by mass, the dripping cannot be prevented from occurring, and the appearance of the coating film may degrade, and when exceeding 95% by mass, the appearance of the coating film may degrade.

Further, the first base coating composition may contain other pigment than the above colored pigment and photoluminescent pigment. As for the other pigment, the extender and the like can be used. For example, calcium carbonate, barium sulfate, clay, talc and the like can be used as the extender.

Further, the first base coating composition may contain a viscosity control agent as another additive with the intention of preventing the first base coat from becoming familiar with the clear coating film described below and of securing excellent coating workability. As for the viscosity control agent, a viscosity control agent having a thixotropic property can be generally used. Examples of the viscosity control agents having a thixotropic property include polyamide-based materials such as crosslinked or non-crosslinked resin particles, a swelling dispersion of aliphatic acid amide, amide-based aliphatic acid, and phosphates of long-chain polyaminoamide; polyethylene-based materials such as a colloidal swelling dispersion of polyethylene oxide; organic bentonite-based materials such as organic acid smectite clay and montmorillonite; inorganic pigments such as aluminum silicate and barium sulfate; and flat pigments capable of developing viscosity depending on a shape of the pigment.

Further, the first base coating composition may contain, other than the above components, additives usually added to the coating composition such as a surface conditioner, a thickener, an antioxidant, an anti-UV agent and a defoamer. The compounding amounts thereof are within known ranges.

A method of preparing the first base coating composition having the above composition is not particularly limited, and a known method can be used to prepare. Specifically, the first base coating composition can be prepared by kneading and dispersing the above respective components using a kneader or a roller.

### <First Clear Coating Composition Application Step>

A first clear coating composition application step is a step of coating the first clear coating composition on the object to be coated that has undergone the above first base coating composition application step. That is, in the present step, an uncured first clear coating film is formed by coating the first clear coating composition on an uncured first base coating film formed by the first base coating composition application step. As for an application method, an electrostatic coating is preferably used.

Here, in the present specification, “uncured” means a state that is not completely cured and also contains a coating film after preheat. That is, according to the present embodiment, a preheat step may be disposed between the first base coating composition application step and the first clear coating composition application step.

The first clear coating composition has, in addition to a function of protecting the first base coating film, a function of improving the appearance of the multilayer coating film by smoothening unevenness or the like of a surface of the first base coating film caused by the photoluminescent pigment. As for the first clear coating composition, a clear coating composition containing the coating film forming resin, the curing agent and an additive is used.

For example, the acrylic resin, polyester resin, epoxy resin, and urethane resin can be used as the coating film forming resin compounded in the first clear coating composition, and these are used in combination with the curing agent such as the amino resin or polyisocyanate resin. A combination of the acrylic resin or polyester resin and the amino resin or polyisocyanate resin can be preferably used from the viewpoint of the transparency of the coating film or the like.

The first clear coating composition is coated wet on wet after coating the above first base coating composition. Therefore, the viscosity control agent is preferably added with an intension of preventing the dripping from occurring, other than preventing the familiarity and conversion between these coating films from occurring. An addition amount of the viscosity control agent is preferably from 0.01 to 10 parts by mass, more preferably from 0.02 to 8 parts by mass, and still more preferably from 0.03 to 6 parts by mass, to 100 parts by mass of the resin solid content in the first clear coating composition. The appearance of the obtained multilayer coating film may degrade when the addition amount of the viscosity control agent exceeds 10 parts by mass. Further, when the addition amount of the viscosity control agent is less than 0.1 parts by mass, the viscosity control effect cannot be sufficiently obtained, and the dripping or the like may occur during formation of the coating film.

As a coating composition form of the first clear coating composition, any one of an organic solvent type, an aqueous type (water-soluble, water-dispersible, or emulsion), a non-aqueous dispersion type and a powder type may be used. Further, the first clear coating composition may contain, as needed, a curing catalyst, a surface modifying agent or the like responding to the coating composition form.

For example, a resin that is rendered water-soluble by neutralizing the above coating film forming resin with a base can be used as an aqueous first clear coating composition. A neutralization is performed by adding a tertiary amine like dimethylethanolamine and trimethylamine before or after the polymerization.

As for the first clear coating composition, a commercially available product can be used. For example, SPO-171 Clear (acrylmelamine-based solvent type clear coating composition) manufactured by Nippon Paint Co., Ltd. can be used as the first clear coating composition.

### <Baking Step (Heating and Curing Step of First Uncured Coating Film)>

A baking step is a step of curing by baking the uncured coating film on the object to be coated by heating the object to be coated that has undergone the above first clear coating composition application step. That is, the present step is a step of simultaneously baking and curing an uncured first base coating film formed in the first base coating composition application step and the uncured first clear coating film formed in the first clear coating composition application step.

A baking temperature of the present step is preferably from 100 to 180° C., and a more preferable baking temperature is from 120 to 160° C. Further, a baking time of the present step varies depending on the baking temperature, but the baking time is preferably from 10 to 30 minutes when the baking temperature is from 120 to 160° C.

In the present specification, the first base coating film and first clear coating film, which were baked and cured by the present step, are called a first cured coating film in combination. The first cured coating film has preferably a 25° L value of 60 or less and a 25° C. value of 30 or more. Here, the 25° L value is an indicator of the brightness, and, specifically, can be measured using CM512m-3 (a spectrophotometric colorimeter manufactured by Konica Minolta, Inc.). Further, the C value is an indicator of the saturation, is represented by a definition formula (a²+b²)^{1/2}, and can be measured using CM512m-3 (a spectrophotometric colorimeter manufactured by Konica Minolta, Inc.) in the same manner as the 25° L value.

The film thickness of the first base coat is preferably from 5 to 35 μm and more preferably from 10 to 25 μm in a dry state. The multilayer coating film having an excellent feeling of depth and feeling of cubic photoluminescence can be obtained when the film thickness of the first base coating film is within this range. Further, a film thickness of the first clear coating film is preferably from 10 to 80 μm, and more preferably from 20 to 60 μm in a dry state. When the film thickness of the first clear coating film exceeds 80 μm, the sharpness degrades, and inconveniences such as irregularity, pinhole or flow may occur during coating. Further, when the film thickness of the first clear coating film is less than 10 μm, cutting of the film may occur.

### <Second Base Coating Composition Application Step>

A second base coating composition application step is a step of coating the second base coating composition on the object to be coated that has undergone the above first base coating composition application step, top clear coating composition application step and baking step. That is, in the present step, an uncured second base coating film is formed on a first cured coating film formed of a baked and cured first base coating film and a first clear coating film. An electrostatic coating is preferably used as an application method.

In the same manner as the above first base coating composition, an aqueous base coating composition containing the colored pigment, photoluminescent pigment, and the coating film forming resin is used as the second base coating composition. The same resin as the above first base coating composition can be used as the coating film forming resin. Therefore, the description thereof will be omitted below.

The second base coating composition is adjusted in its composition such that a light transmittance of a wavelength region corresponding to the paint color of the multilayer coating film within a wavelength from 400 to 700 nm is 60 to 90% in the second base coating film (cured) formed from the second base coating composition. Specifically, the light transmittance of the second base coating film (cured) in a wavelength region corresponding to the paint color of the multilayer coating film is adjusted to from 60 to 90% by adjusting compounding types and compounding amounts of the colored pigment and photoluminescent pigment, which will be described below. Thus, the second base coating film functions as a colored transmission layer in the multilayer coating film of the respective paint colors, and an excellent feeling of depth and feeling of cubic photoluminescence can be obtained.

Here, the wavelength region corresponding to the paint color of the multilayer coating film means, as was described above, a wavelength region of from 440 to 480 nm, when the paint color of the multilayer coating film is blue, for example. Further, when the paint color of the multilayer coating film is red, for example, it means a wavelength region of from 620 to 700 nm. Still further, when the paint color of the multilayer coating film is green, it means a wavelength region of from 510 to 570 nm.

The light transmittance is measured as shown below.

The light transmittance is obtained by measuring the light transmittance of a single coating film formed using the second base coating composition for every 10 nm in a wavelength region of from 300 to 700 nm using a spectrophotometer (U-3310 manufactured by Hitachi Limited) and by calculating an average of measurements.

A colored pigment compounded in the second base coating composition is selected from the colored pigments compounded in the first base coating composition. Among these, a colored pigment having a small particle size, and high transparency and saturation is preferably used. Thus, high transparency of the second base coating film formed from the second base coating composition is secured, and a multilayer coating film having an excellent feeling of depth and feeling of cubic photoluminescence can be obtained.

The colored pigment compounded in the second base coating composition is selected such that the first base coating composition and second base coating composition become similar shade. It is preferable that a colored pigment of the same type as the colored pigment compounded in the first base coating composition is used as the colored pigment compounded in the second base coating composition.

A content of the colored pigment in the second base coating composition is preferably from 0.01 to 10% by mass in a pigment mass concentration (PWC) in the second base coating composition. A multilayer coating film having an excellent feeling of depth and feeling of cubic photoluminescence can be obtained, when the content of the colored pigment is within this range. The content of the colored pigment is more preferably from 1 to 5% by mass. It should be noted that the PWC of the colored pigment is, as was described above, a mass ratio of all colored pigments relative to a total mass of all pigments including the pigments other than the colored pigments and all resin components and is calculated by the formula (1) described above.

The photoluminescent pigment compounded in the second base coating composition is selected from among the above photoluminescent pigments compounded in the first base coating composition. However, the photoluminescent pigment compounded in the second base coating composition has the volume average particle size (D₅₀) of preferably from 7 to 50 μm and more preferably from 10 to 50 μm. Different from the first base coating composition, the photoluminescent pigment having a relatively large particle size is preferably used to obtain the feeling of cubic photoluminescent. The transparency of the second base coat is secured when the volume average particle size (D₅₀) of the photoluminescent pigment is within this range. Therefore, the multilayer coating film having an excellent feeling of depth and feeling of cubic photoluminescence can be obtained. A more preferable volume average particle size (D₅₀) is from 10 to 35 μm.

In the present embodiment, the same as for the first base coating composition, at least one kind of scale-like photoluminescent pigment selected from the group consisting of an aluminum-based photoluminescent pigment and a mica-based photoluminescent pigment is particularly preferably used as the photoluminescent pigment compounded in the second base coating composition. An aluminum flake, an interference mica or the like can be used as the photoluminescent pigment corresponding to these.

A content of the photoluminescent pigment compounded in the second base coating composition is from 0.01 to 1.1% by mass in a pigment mass concentration (PWC) in the second base coating composition. That is, the content of the photoluminescent pigment compounded in the second base coating composition is less and extremely small compared with the content of the photoluminescent pigment compounded in the first base coating composition. A multilayer coating film having an excellent feeling of depth and feeling of cubic photoluminescence can be obtained because the transparency of the second base coat can be secured when the PWC of the photoluminescent pigment is within this range. The PWC of the photoluminescent pigment is more preferably from 0.05 to 0.5% by mass. The PWC of the photoluminescent pigment is, as was described above, a mass ratio of all photoluminescent pigments relative to a total mass of all pigments including the pigments other than the photoluminescent pigments and all resin components and is calculated by the formula (2) described above.

Here, while a conventional second base coating composition does not contain the photoluminescent pigment, the second base coating composition of the present embodiment is largely different from the conventional one in a point of containing the photoluminescent pigment. Thus, a granular unpleasant feeling of a ring-like coating film defect portion generated in the past upon repairing can be eliminated when a slight amount of the photoluminescent pigment is contained in the second base coating film formed of the second base coating composition. Therefore, according to the present embodiment, a multilayer coating film having, in addition to excellent feeling of depth and feeling of cubic photoluminescence, excellent repairability can be obtained. Further, according to the present embodiment, the cost can be reduced because there is no need of separately preparing a repair-dedicated coating composition for the second base coating film and the second base coating composition itself can be used for repairing the second base coating film.

The second base coating composition is prepared in the same manner as the first base coating composition according to a known method.

### <Top Clear Coating Composition Application Step>

A top clear coating composition application step is a step of coating the top clear coating composition on the object to be coated that has undergone the second base coating composition application step described above. That is, in the present step, an uncured top clear coating film is formed on an uncured second base coating film. The electrostatic coating is preferably used as a coating method.

According to the present embodiment, a pre-heat step may be disposed between the second base coating composition application step and the top clear coating composition application step.

A top clear coating composition has a function of protecting the second base coating film and improving the appearance of the multilayer coating film. As for the top clear coating composition, an acid-epoxy curing system clear coating composition is preferably used. This acid-epoxy curing system clear coating composition contains an acid anhydride-containing acrylic resin (a), a carboxyl-containing ester resin (b), and a hydroxyl- and epoxy-containing acrylic resin (c). The top clear coating composition is a high solid content coating composition and a top clear coating film formed from this top clear coating composition has excellent acid resistance.

A molar ratio of the carboxyl groups contained in the acid anhydride-containing acrylic resin (a) and the carboxyl-containing polyester resin (b) and the epoxy groups contained in the hydroxyl- and epoxy-containing acrylic resin (c) is preferably from 1/1.4 to 1/0.6 and more preferably from 1/1.2 to 1/0.8. When the molar ratio thereof exceeds 1/0.6, the curability of the coating film may degrade, and, when the molar ratio thereof is less than 1/1.4, the coating film may turn yellow.

Further, a molar ratio of the carboxyl groups contained in the acid anhydride containing acrylic resin (a) and a total of the hydroxyl groups contained in the carboxyl-containing polyester resin (b) and the hydroxyl- and epoxy-containing acrylic resin (c) is preferably from 1/2.0 to 1/0.5 and more preferably from 1/1.5 to 1/0.7. When the molar ratio of these exceeds 1/0.5, the curability of the coating film may degrade, and, when the molar ratio of these is less than 1/2.0, the water resistance may degrade because the number of hydroxyl groups becomes excessive.

The above respective resins are compounded at contents that satisfy the above preferable molar ratio. Specifically, the respective resins are compounded according to compounding amounts calculated by a calculation method known to a person skilled in the art, based on the hydroxyl values, acid values and epoxy equivalents of the respective resins.

A curing mechanism of the top clear coating composition is as shown below. First, upon heating, the acid anhydride groups in the acid anhydride-containing acrylic resin (a) react with the hydroxyl groups contained in the carboxyl-containing polyester resin (b) and the hydroxyl- and epoxy-containing acrylic resin (c). Thus, crosslinking points are formed and carboxyl groups are generated. Then, the generated carboxyl groups and the carboxyl groups in the carboxyl-containing polyester resin (b) react with the epoxy groups in the hydroxyl- and epoxy-containing acrylic resins (c). Thus, more crosslinking points are formed. As was described above, when three kinds of resins mutually perform a crosslinking reaction, a top clear coating film having a high crosslinking density can be formed.

The top clear coating composition may contain blocked isocyanate with the intention of improving the crosslinking density and water resistance. Further, the top clear coat may contain a UV-absorbent and a hindered amine light stabilizer, an anti-oxidant and the like with the intention of improving the weather resistance of the coating film. Further, crosslinked resin particles as a rheology control agent and a surface conditioner for adjusting appearance may be contained. Still further, with the intention of adjusting the viscosity, alcohol-based solvents (for example, methanol, ethanol, propanol, butanol or the like), hydrocarbon-based and ester-based solvents may be contained as a diluent.

In the case of using the crosslinked resin particles, the crosslinked resin particles are added at an amount of from 0.01 to 10 parts by mass and preferably at an amount of from 0.1 to 5 parts by mass to 100 parts by mass of the resin solid content of the top clear coating composition. When the addition amount of the crosslinked resin particles exceeds 10 parts by mass, the appearance may degrade, and, when the addition amount is less than 0.01 parts by mass, the rheology control effect may not be obtained.

The respective resins have an acid group as a functional group. Therefore, these can be rendered water-soluble by neutralizing with an amine.

Further, as for the top clear coating composition, a commercially available product can be used. For example, MAC-O-1820 Clear (one pack type) or O-2100 Clear (two pack type) manufactured by Nippon Paint Co., Ltd. can be used as a second top clear coating composition.

### <Heating and Curing Step>

The heating and curing step is a step of curing by baking an uncured coating film on the object to be coated by heating the object to be coated that has undergone the above top clear coating composition application step. That is, the present step is a step of simultaneously curing by baking the uncured second base coating film formed in the second base coat application step and the uncured top clear coating film formed in the top clear coating composition application step.

A baking temperature of the present step is preferably from 100 to 180° C. and more preferably from 120 to 160° C. Further, a baking time of the present step varies depending on the baking temperature, but is preferably from 10 to 30 minutes when the baking temperature is from 120 to 160° C.

A dry film thickness of the second base coating film is preferably from 5 to 35 μm, and more preferably from 10 to 25 μm. When the film thickness of the second base coating film is within this range, a high transparency of the second base coating film can be secured and the multilayer coating film having an excellent feeling of depth and feeling of cubic photoluminescence can be obtained.

Further, the dry film thickness of the top clear coating film is preferably from 10 to 80 μm and more preferably from 20 to 60 μm. When the film thickness of the top clear coating film exceeds 80 μm, the sharpness degrades, and inconveniences such as irregularity, pinhole or flow may occur during coating. Further, when the film thickness of the top clear coating film is less than 10 μm, cutting of the film may occur.

According to the multilayer coating film formed according to the forming method of the multilayer coating film of the present embodiment described above, the following effects can be obtained.

First, the first base coating film functions as a reflective layer having a high feeling of photoluminescence, since the first base coating composition is designed such that, in the first base coating film containing the colored pigment and photoluminescent pigment, the light reflectance in a wavelength region corresponding to the paint color of the multilayer coating film is from 10 to 30%.

Further, the second base coating film functions as a colored transmissive layer having high transparency, since the second base coating composition is designed such that, in the second base coating film containing the colored pigment and photoluminescent pigment, the light transmittance in a wavelength region corresponding to the paint color of the multilayer coating film is from 60 to 90%.

As a result, according to the present embodiment, in the respective paint colors, the multilayer coating film having a more excellent feeling of depth and feeling of cubic photoluminescence than in the prior art can be obtained. The present embodiment can be preferably applied to the multilayer coating film of the paint color that is low in the brightness and has high saturation, of, for example, red, blue and green.

Further, different from the convention, by making it contain the photoluminescent pigment in the second base coating film, the granular unpleasant feeling of a ring-like coating film defect portion generated in the past during repairing can be eliminated.

Therefore, according to the present embodiment, the multilayer coating film having, in addition to more excellent feeling of depth and a feeling of cubic photoluminescence than in the prior art, excellent repairability can be obtained.

Further, according to the present embodiment, the cost can be reduced because there is no need of separately preparing a repair-dedicated coating composition for the second base coating film and the second base coating composition itself can be used for repairing the second base coating film.

The present invention is not limited to the above embodiments, and, modifications, improvements or the like within the range that can achieve an object of the present invention are included in the present invention.

Although the first clear coating composition application step is included in the present embodiment, the present invention is not limited to this. Without including the first clear coating composition application step, after the first base coating composition application, preheating as necessary, then the second base coating composition may be coated wet on wet. In this case, the uncured first base coating film, the second base coating film and the top clear coating film are simultaneously baked and cured, according to the heating and curing Step.

### EXAMPLES

Next, the present invention will be described in more detail with reference to examples. However, the present invention is not limited to these examples. Hereinafter, unless otherwise noted, “parts” and “%” are based on mass.

### Manufacture Example 1

### Preparation of First Base Coating Composition

A first base coating composition was prepared.

Specifically, in addition to
(1) 236 parts of an acrylic emulsion resin manufactured by Nippon Paint Co., Ltd. (an average particle size: 150 nm, a nonvolatile portion: 20%, a solid acid value: 20 mg KOH/g, a hydroxyl value: 40 mg KOH/g),
(2) 10 parts of a 10% aqueous solution of dimethylethanolamine,
(3) 28.3 parts of an aqueous acryl resin manufactured by Nippon Paint Co., Ltd., (a nonvolatile portion: 30%, a solid acid value: 40 mg KOH/g, a hydroxyl value: 50 mg KOH/g),
(4) 8.6 parts of Primepole PX-1000 manufactured by Sanyo Kasei Co., Ltd., (a bifunctional polyether polyol, a number average molecular weight: 400, a hydroxyl value: 278 mg KOH/g, a ratio of primary/secondary hydroxyl values=63/37, a solid content: 100%),
(5) 21.5 parts of Cymel 204 manufactured by Mitsui Cytec Inc., (an alkylated melamine resin, a nonvolatile portion: 100%)
(6) 26 parts of “NeoRez R-9603” manufactured by Avecia Resins (a polycarbonate-based urethane emulsion resin, a nonvolatile portion: 33%) and,
(7)0.2 parts of lauryl acid phosphate, colored pigments and photoluminescent pigments shown in Table 1 were compounded at contents shown in Table 1. After that, a mixture was homogeneously dispersed and a first base coating composition was obtained.

“93-0647” and “01-0651” in Table 1 represent aluminum photoluminescent pigment “Alpaste 93-0647” and Alpaste 01-0651″ manufactured by Toyo Aluminum K.K., “G-314” represents a cyanine blue pigment “Cyanine Blue G-314” manufactured by Sanyo Color Works Ltd., “R-5000” represents a carbon black pigment “Carbon Black R-5000” manufactured by Columbia Carbon Ltd., and “Violet BL” represents a dioxazine violet pigment “Violet BL” manufactured by Clariant Japan.

### Manufacture Example 2

### Preparation of Second Base Coating Composition

The same as the first base coating composition prepared in Manufacture Example 1, in addition to the above (1) to (7) that are components other than the pigments, in the respective examples and comparative examples, colored pigments and photoluminescent pigments shown in Table 2 were compounded at contents shown in Table 2. After that, by homogeneously dispersing, second base coating compositions of respective examples and comparative examples were obtained.

It should be noted that, in Table 2, “Xirallic T60-10” represents a metal oxide-coated alumina flake “Xirallic T60-10” manufactured by Merck Ltd., Japan), “Red P2GL” represents a perylene red pigment “P2GL” manufactured by Clariant Japan, and “Green 6YKPN” represents a cyanine green pigment “Lionol Green 6YKPN” manufactured by Toyo Ink.

### Examples 1 to 12 and Comparative Examples 1 to 4

A SPCC-SD steel sheet (dull steel sheet) treated with zinc phosphate and measuring 20 cm wide by 30 cm long by 0.8 mm thick was subjected to electrodeposition coating with a cation electrodeposition coating composition “Power Top U-50” manufactured by Nippon Paint Co., Ltd. so that a dry film thickness is 20 μm. The resultant was baked at 160° C. for 30 minutes.

Then, on the obtained electrodeposition coating film, a gray intermediate coating composition “Orga P-2 Gray” (polyester-melamine resin-based coating composition manufactured by Nippon Paint Co., Ltd.) was spray coated such that a dry film thickness is 30 μm, followed by baking at 140° C. for 20 minutes, thus, an object to be coated provided with an intermediate coating film was prepared.

Then, the first base coating composition prepared in Manufacture Example 1 was coated on the obtained intermediate coating film using a Cartridge Bell (a rotary atomizing coater manufactured by ABB Industries) such that a dry film thickness is 15 μm. After preheating at 80° C. for 3 minutes, a first clear coating composition “SPO-171” (acrylic melamine-based solvent type clear coating composition, manufactured by Nippon Paint Co., Ltd.) was coated wet on wet so that a dry film thickness is 30 μm using a rotary atomizing electrostatic coater, a μμ Bell by a common name. After setting for 7 minutes, by baking at 140° C. for 30 minutes, a first cured coating film was obtained.

The second base coating compositions of respective examples and comparative examples prepared in Manufacture Example 2 were coated on the obtained first cured coating film using a Cartridge Bell (a rotary atomizing coater manufactured by ABB Industries) so that a dry film thickness is 15 μm. After preheating at 80° C. for 3 minutes, a top clear coating composition “MACFLOW O-1810 Clear” (an acid epoxy curing type acrylic resin-based coating composition, manufactured by Nippon Paint Co., Ltd.) was coated wet on wet so that a dry film thickness is 35 μm using a rotary atomizing electrostatic coater, a μμ Bell by a common name. After coating, followed by baking at 140° C. for 30 minutes, thus multilayer coating films of the respective examples and comparative examples were obtained.

### <Evaluation>

### [Feeling of Depth]

The multilayer coating films of the respective examples and comparative examples were subjected to a test that evaluates the feeling of depth. Specifically, the multilayer coating films were visually evaluated based on the following evaluation criteria.

### (Evaluation Criteria of Feeling of Depth)

1: An intense feeling of depth is felt.
2: An appropriate feeling of depth is felt.
3: A feeble feeling of depth is felt.
4: The feeling of depth is not felt.

### [Feeling of Cubic Photoluminescence]

The multilayer coating films of the respective examples and comparative examples were subjected to a test that evaluates the feeling of cubic photoluminescence. Specifically, the multilayer coating films were visually evaluated based on the following evaluation criteria.

### (Evaluation Criteria of Cubic Photoluminescence)

1: An intense feeling of cubic photoluminescence is felt.
2: A slightly intense feeling of cubic photoluminescence is felt.
3: An appropriate feeling of cubic photoluminescence is felt.
4: A feeble feeling of cubic photoluminescence is felt.
5: The feeling of cubic photoluminescence is not felt.

### [Light Reflectance]

The light reflectance of the first base coating film was measured in a wavelength of from 440 to 480 nm. Specifically, a multilayer coating film (an electrodeposition coating film, an intermediate coating film, a first base coating film) with the first base as a topmost layer was formed on a steel plate as an object to be coated, an intensity of light beam reflected by the multilayer coating film with the first base as the topmost layer was measured for every 10 nm in a wavelength region corresponding to the paint color by a spectrophotometer (U-3310, manufactured by Hitachi Ltd.) and the light reflectance was calculated. Results are shown in Table 1.

### [Light Transmittance]

The second base coating films of the respective examples and comparative examples were subjected to a light transmittance measurement in a wavelength of from 440 to 480 nm. Specifically, the light transmittance of a single coating film formed with the second base coating composition was measured for every 10 nm in a wavelength of from 300 to 700 nm using the spectrophotometer (U-3310, manufactured by Hitachi Ltd.) and was calculated as an average value thereof. Results are shown in Table 2.

### [Repairability]

The multilayer coating films of the respective examples and comparative examples were subjected to a test that evaluates the repairability. Specifically, a portion to be repaired was ground with water using a #800 sandpaper until the intermediate coating film was ground out. Then, a grinding residue was removed by wiping, followed by coating the first base coating composition. Then, after leaving for 10 minutes, the second base coating composition and the top clear coating composition were sequentially coated slightly larger than a range of a ground out portion, followed by baking and curing, thus, a repaired coating film was obtained. A color phase of the obtained repaired coating film was evaluated according to the following evaluation criteria. Further, the feeling of cubic photoluminescent of the repaired coating film was evaluated based on the following evaluation criteria. Results are shown in Table 2.

### (Evaluation Criteria of Color Phase)

1: Too dense.
2: Matched.
3: Thinner.
4: Utterly unmatched.

TABLE 1

| | | | | Light | | |
|---|---|---|---|---|---|---|
| | | | | reflectance | | |
| | | | | (%) | | |
| | Compounding | D50 | | (Wavelength | 25° L | 25° C. |
| | composition | (μm) | PWC (%) | 440~480 nm) | value | value |
| First | 93-0647 | 20 | 9.0 | 22 | 36 | 50 |
| base | 01-0651 | 9 | 2.4 | | | |
| | Blue G-314 | — | 9.7 | | | |
| | Black R-5000 | — | 0.6 | | | |
| | Violet BL | — | 2.1 | | | |
| | (Subtotal) | 29.0 | 23.8 | | | |

TABLE 2

| | | Compar- | Compar- | Compar- | Compar- | | | | |
|---|---|---|---|---|---|---|---|---|---|
| | | ative | ative | ative | ative | Example | Example | Example | Example |
| | | Example 1 | Example 2 | Example 3 | Example 4 | 1 | 2 | 3 | 4 |
| Second | 93-0647 | 0.01 | 0.02 | — | 1.50 | — | 0.01 | 0.04 | 0.06 |
| base | 01-0651 | — | — | — | — | — | — | — | — |
| (PWC) | Xirallic | — | — | — | — | 0.01 | — | — | — |
| | T60-10 | | | | | | | | |
| | Blue | 0.50 | 1.00 | 2.00 | 3.00 | 2.00 | 2.00 | 2.00 | 2.00 |
| | G-314 | | | | | | | | |
| | Red P2GL | — | — | — | — | — | — | — | — |
| | Green | — | — | — | — | — | — | — | — |
| | 6YKPN | | | | | | | | |
| | R-5000 | 0.00 | 0.00 | 0.00 | 0.00 | 0.00 | 0.00 | 0.00 | 0.00 |
| | Black | | | | | | | | |
| | Violet BL | 0.05 | 0.20 | 0.20 | 0.20 | 0.20 | 0.20 | 0.20 | 0.20 |
| | (Subtotal) | 0.56 | 1.22 | 2.20 | 3.20 | 2.21 | 2.21 | 2.24 | 2.26 |
| Design | Color phase | Blue | Blue | Blue | Blue | Blue | Blue | Blue | Blue |
| property of | Feeling of | 4 | 3 | 2 | 4 | 2 | 2 | 2 | 2 |
| multilayer | depth | | | | | | | | |
| coating | Feeling of | 4 | 4 | 5 | 1 | 3 | 3 | 3 | 3 |
| film | cubic | | | | | | | | |
| | photo- | | | | | | | | |
| | luminescence | | | | | | | | |
| Light transmittance | | 40 | 55 | 75 | 55 | 75 | 75 | 75 | 75 |
| Blue: Wavelength | | NG | NG | OK | NG | OK | OK | OK | OK |
| 440~480 nm | | | | | | | | | |
| Green: Wavelength | | | | | | | | | |
| 510~570 nm | | | | | | | | | |
| Red: Wavelength | | | | | | | | | |
| 650~700 nm | | | | | | | | | |
| Repairability | Color phase | 4 | 3 | 1 | 4 | 2 | 2 | 2 | 2 |
| | Feeling | 4 | 3 | 5 | 1 | 3 | 3 | 3 | 3 |
| | of cubic | | | | | | | | |
| | photo- | | | | | | | | |
| | luminescence | | | | | | | | |
| | | Example | Example | Example | Example | Example | Example | Example | Example |
| | | 5 | 6 | 7 | 8 | 9 | 10 | 11 | 12 |
| Second | 93-0647 | 0.10 | 0.20 | 0.60 | 1.00 | 1.10 | — | 0.10 | 0.10 |
| base | 01-0651 | — | — | — | — | — | 0.10 | — | — |
| (PWC) | Xirallic | — | — | — | — | — | — | — | — |
| | T60-10 | | | | | | | | |
| | Blue | 2.00 | 2.00 | 2.00 | 2.00 | 3.00 | 2.00 | — | — |
| | G-314 | | | | | | | | |
| | Red P2GL | — | — | — | — | — | — | 2.00 | — |
| | Green | — | — | — | — | — | — | — | 2.00 |
| | 6YKPN | | | | | | | | |
| | R-5000 | 0.00 | 0.00 | 0.00 | 0.00 | 0.00 | 0.00 | 0.00 | 0.00 |
| | Black | | | | | | | | |
| | Violet BL | 0.20 | 0.20 | 0.20 | 0.20 | 0.20 | 0.20 | 0.00 | 0.00 |
| | (Subtotal) | 2.30 | 2.40 | 2.80 | 3.20 | 4.30 | 2.30 | 2.10 | 2.10 |
| Design | Color phase | Blue | Blue | Blue | Blue | Blue | Blue | Red | Green |
| property of | Feeling of | 2 | 2 | 2 | 2 | 2 | 2 | 2 | 2 |
| multilayer | depth | | | | | | | | |
| coating | Feeling of | 3 | 3 | 3 | 3 | 2 | 5 | 3 | 3 |
| film | cubic | | | | | | | | |
| | photo- | | | | | | | | |
| | luminescence | | | | | | | | |
| Light transmittance | | 73 | 72 | 71 | 70 | 65 | 75 | 85 | 85 |
| Blue: Wavelength | | OK | OK | OK | OK | OK | OK | OK | OK |
| 440~480 nm | | | | | | | | | |
| Green: Wavelength | | | | | | | | | |
| 510~570 nm | | | | | | | | | |
| Red: Wavelength | | | | | | | | | |
| 650~700 nm | | | | | | | | | |
| Repairability | Color phase | 2 | 2 | 2 | 2 | 2 | 2 | 2 | 2 |
| | Feeling | 3 | 3 | 3 | 3 | 2 | 3 | 3 | 3 |
| | of cubic | | | | | | | | |
| | photo- | | | | | | | | |
| | luminescence | | | | | | | | |

As shown in Table 1 and Table 2, it was confirmed that a multilayer coating film having, in addition to an excellent feeling of depth and feeling of cubic photoluminescence, excellent repairability can be obtained.

### INDUSTRIAL APPLICABILITY

According to the present invention, a multilayer coating film having, in addition to an excellent feeling of depth and feeling of cubic photoluminescence, excellent repairability can be obtained. Therefore, a method of forming a multilayer coating film of the present invention is suitable for an object to be coated having a complicated and large shape such as an outer plate of an automotive body and the like.

1. A method of forming a multilayer coating film comprising:
forming a first base coating film by coating a first base coating composition containing a colored pigment and a photoluminescent pigment on an object to be coated;
forming a second base coating film by coating a second base coating composition containing a colored pigment and a photoluminescent pigment on the object to be coated that has undergone the first base coating composition application step;
applying a top clear coating composition on the object to be coated that has undergone the second base coating composition application step; and
heating and curing the uncured coating films on the object to be coated, wherein
a pigment weight concentration (PWC) of the photoluminescent pigment in the second base coating composition is from 0.01 to 1.1% by mass,
the first base coating film formed from the first base coating composition has a light reflectance of from 10 to 30% in a wavelength region corresponding to a paint color of the multilayer coating film in a wavelength of from 400 to 700 nm, and
the second base coating film formed from the second base coating composition has a light transmittance of from 60 to 90% in the wavelength region.

2. The method of forming a multilayer coating film according to claim 1, wherein a pigment weight concentration (PWC) of the colored pigment in the second base coating composition is from 0.01 to 10% by mass.

3. The method of forming a multilayer coating film according to claim 1, wherein the pigment weight concentration (PWC) of the photoluminescent pigment in the first base coating composition is from 10 to 15% by mass.

4. The method of forming a multilayer coating film according to claim 1, wherein any of the photoluminescent pigment in the first base coating composition and the photoluminescent pigment in the second base coating composition is at least one kind of scale-like photoluminescent pigment selected from the group consisting of an aluminum-based photoluminescent pigment and a mica-based photoluminescent pigment.

5. The method of forming a multilayer coating film according to claim 1, further comprising:
applying a first clear coating composition on the object to be coated that has undergone the first base coating composition application step; and
baking and curing the uncured coating films on the object to be coated, wherein the first clear coating composition is applied on the object to be coated that has undergone the first base coating composition application, and the baking and curing the uncured coating films on the object to be coated, are performed between the first base coating composition application and the second base coating composition application.

6. A multilayer coating film formed by the method of forming the multilayer coating film according to claim 1.

7. The method of forming a multilayer coating film according to claim 2, wherein the pigment weight concentration (PWC) of the photoluminescent pigment in the first base coating composition is from 10 to 15% by mass.

8. The method of forming a multilayer coating film according to claim 2, wherein any of the photoluminescent pigment in the first base coating composition and the photoluminescent pigment in the second base coating composition is at least one kind of scale-like photoluminescent pigment selected from the group consisting of an aluminum-based photoluminescent pigment and a mica-based photoluminescent pigment.

9. The method of forming a multilayer coating film according to claim 3, wherein any of the photoluminescent pigment in the first base coating composition and the photoluminescent pigment in the second base coating composition is at least one kind of scale-like photoluminescent pigment selected from the group consisting of an aluminum-based photoluminescent pigment and a mica-based photoluminescent pigment.

10. The method of forming a multilayer coating film according to claim 4, wherein any of the photoluminescent pigment in the first base coating composition and the photoluminescent pigment in the second base coating composition is at least one kind of scale-like photoluminescent pigment selected from the group consisting of an aluminum-based photoluminescent pigment and a mica-based photoluminescent pigment.

11. The method of forming a multilayer coating film according to claim 2, further comprising:
applying a first clear coating composition on the object to be coated that has undergone the first base coating composition application; and
baking and curing the uncured coating films on the object to be coated, wherein the first clear coating composition is applied on the object to be coated that has undergone the first base coating composition application, and the baking and curing the uncured coating films on the object to be coated, are performed between the first base coating composition application and the second base coating composition application.

12. The method of forming a multilayer coating film according to claim 3, further comprising:
applying a first clear coating composition on the object to be coated that has undergone the first base coating composition application; and
baking and curing the uncured coating films on the object to be coated, wherein the first clear coating composition is applied on the object to be coated that has undergone the first base coating composition application, and the baking and curing the uncured coating films on the object to be coated, are performed between the first base coating composition application and the second base coating composition application.

13. The method of forming a multilayer coating film according to claim 4, further comprising:
applying a first clear coating composition on the object to be coated that has undergone the first base coating composition application; and
baking and curing the uncured coating films on the object to be coated, wherein the first clear coating composition is applied on the object to be coated that has undergone the first base coating composition application, and the baking and curing the uncured coating films on the object to be coated, are performed between the first base coating composition application and the second base coating composition application.

14. A multilayer coating film formed by the method of forming the multilayer coating film according to claim 2.

15. A multilayer coating film formed by the method of forming the multilayer coating film according to claim 3.

16. A multilayer coating film formed by the method of forming the multilayer coating film according to claim 4.
